(19) United States
(12) Patent Application Publication
(10) Pub. No.: US 2024/0359235 A1
(43) Pub. Date: Oct. 31, 2024

(54) CLEARING AN OCCLUSION FROM A METAL JETTING PRINTHEAD NOZZLE WITHOUT CONTACT

(71) Applicant: Additive Technologies, LLC, DBA ADDiTEC, Palm City, FL (US)

(72) Inventors: Gary D. Redding, Dansville, NY (US); Lyle G. Dingman, Fairport, NY (US); Peter M. Gulvin, Webster, NY (US)

(73) Assignee: Additive Technologies, LLC, DBA ADDiTEC, Palm City, FL (US)

(21) Appl. No.: 18/307,352

(22) Filed: Apr. 26, 2023

(51) Int. Cl. B22F 10/22; B22F 12/10; B22F 12/20; B22F 12/53; B22F 12/90

(52) U.S. Cl. CPC B22F 10/22; B22F 12/10; B22F 12/20; B22F 12/53; B22F 12/90; B33Y 10/00; B33Y 30/00; B33Y 40/00

(57) ABSTRACT

A method for printing a 3D part includes decreasing a temperature of a build material in a nozzle of a 3D printer below a melting point of the build material, which causes the build material in the nozzle to transition from a liquid state to a solid state. The method also includes increasing the temperature of the build material in the nozzle above the melting point of the build material, which causes the build material in the nozzle to transition from the solid state to a sludgy state. An occlusion and the build material in the sludgy state are ejected from the nozzle.

### TECHNICAL FIELD

The present teachings relate generally to three-dimensional (3D) printing and, more particularly, to systems and methods for clearing an occlusion from a metal jetting printhead nozzle without physically contacting the nozzle.

### BACKGROUND

When printing with a molten metal build material using a 3D metal printer, there are many challenges. One of the challenges is keeping the nozzle free from occlusions. An occlusion refers to a build-up of material in and/or around the bore of the nozzle. For example, the occlusion may be or include an annular build-up of a metal oxide on the inner surface of the nozzle that defines the nozzle bore, which reduces the effective diameter of the nozzle bore.

There have been improvements to 3D metal printers to minimize occlusions; however, occlusions still form to some degree around the nozzle bore. Occlusion build-up can cause many jetting issues, such as: a decrease in drop size and/or drop mass, satellites (e.g., miniature drops often at multiple angles), overactive meniscus activity of the molten metal at the nozzle bore, and overall jetting instability. There have been several mitigation strategies used in attempts to clear the occlusions from the nozzle, but all of the conventional mitigation strategies involve a mechanical contact/intervention (e.g., scrape, probe, etc.) to clear the occlusion. Mechanical intervention can be difficult and operator-dependent, so it would likely require an automated solution that would add cost and complexity to the 3D metal printer.

### SUMMARY

The following presents a simplified summary in order to provide a basic understanding of some aspects of one or more embodiments of the present teachings. This summary is not an extensive overview, nor is it intended to identify key or critical elements of the present teachings, nor to delineate the scope of the disclosure. Rather, its primary purpose is merely to present one or more concepts in simplified form as a prelude to the detailed description presented later.

A method for printing a 3D part is disclosed. The method includes decreasing a temperature of a build material in a nozzle of a 3D printer below a melting point of the build material, which causes the build material in the nozzle to transition from a liquid state to a solid state. The method also includes increasing the temperature of the build material in the nozzle above the melting point of the build material, which causes the build material in the nozzle to transition from the solid state to a sludgy state. An occlusion and the build material in the sludgy state are ejected from the nozzle.

A method for clearing an occlusion from a nozzle of a 3D printer is also disclosed. The method includes determining that the occlusion is present within the nozzle. The occlusion is a substantially annular ring including a metal oxide that is attached to an inner surface of the nozzle, which reduces an effective diameter of a bore through the nozzle. The method also includes ceasing to generate jetting pulses, which stops drops of a build material from being ejected from the nozzle. The build material includes a metal. The method also includes un-aligning the nozzle from a build plate. The method also includes decreasing a temperature of the build material in the 3D printer, which causes a portion of the build material in the nozzle to fall below a melting point of the build material and thus transition from a liquid state to a solid state within the nozzle. The method also includes resuming generating the jetting pulses, which generates heat within the nozzle that at least partially melts the build material therein such that the build material transitions from the solid state to a sludgy state in the nozzle. The jetting pulses cause the occlusion and the build material in the sludgy state to be ejected from the nozzle together, thereby increasing the effective diameter of the bore through the nozzle. The method also includes increasing the temperature of the build material in the 3D printer using a heating element to cause the build material in the nozzle to be in the liquid state. The temperature is increased after the occlusion and the build material in the sludgy state are ejected from the nozzle. The method also includes re-aligning the nozzle and the build plate after the temperature of the build material is increased. The method also includes printing a 3D part with the build material on the build plate once the nozzle and the build plate are re-aligned.

A method for printing a 3D part is also disclosed. The method includes ejecting a metal alloy from a nozzle of a 3D printer using an electromagnetic force. The metal alloy cools and solidifies after being ejected to form the 3D part. The method also includes determining that an occlusion is present within the nozzle. The method also includes decreasing a temperature of the metal alloy in the nozzle below a melting point of the metal alloy, which causes the metal alloy in the nozzle to transition from a liquid state to a solid state. The method also includes increasing the temperature of the metal alloy in the nozzle above the melting point of the metal alloy, which causes the metal alloy in the nozzle to transition from the solid state to a sludgy state. The occlusion and the metal alloy in the sludgy state are ejected from the nozzle.

A 3D printer is also disclosed. The 3D printer includes a nozzle configured to eject a plurality of drops of a build material. The 3D printer also includes a computing system configured to perform operations. The operations include causing a temperature of the build material in the nozzle to decrease below a melting point of the build material, which causes the build material in the nozzle to transition from a liquid state to a solid state. The operations also include causing the temperature of the build material in the nozzle to increase above the melting point of the build material, which causes the build material in the nozzle to transition from the solid state to a sludgy state. An occlusion and the build material in the sludgy state are ejected from the nozzle.

A method for controlling a viscosity of a jetting material in a jetting device is disclosed. The method includes introducing the jetting material into the jetting device. The jetting material flows through a fluidic path in the jetting device. The fluidic path includes an upstream portion and a downstream portion. The method also includes increasing a maximum viscosity of the jetting material in the downstream portion of the fluidic path to be at least 25% higher than the viscosity of the jetting material in the upstream portion of the fluidic path.

In another embodiment, the method includes introducing the build material into the 3D printer. The build material flows through a fluidic path in the 3D printer. The fluidic path includes an upstream portion and a downstream portion. The method also includes increasing the viscosity of the build material in the downstream portion of the fluidic path, which causes a solid fraction of the build material in the downstream portion of the fluidic path to be greater than about 1%.

In another embodiment, the method includes introducing the build material into the 3D printer. The build material flows through a fluidic path in the 3D printer. The fluidic path includes an upstream portion and a downstream portion. The method also includes decreasing the temperature of the build material in the downstream portion of the fluidic path until the temperature in the downstream portion of the fluidic path is above a solidus temperature of the build material and below a liquidus temperature of the build material.

### BRIEF DESCRIPTION OF THE DRAWINGS

The accompanying drawings, which are incorporated in and constitute a part of this specification, illustrate embodiments of the present teachings and together with the description, serve to explain the principles of the disclosure. In the figures:

FIG. 1 depicts a schematic cross-sectional side view of a 3D printer, according to an embodiment.

FIG. 2A depicts an image showing a nozzle bore of the 3D printer with an occlusion therein, according to an embodiment.

FIG. 2B depicts an image showing the nozzle bore with no occlusion therein (e.g., after the occlusion has been removed), according to an embodiment.

FIG. 3 depicts a graph showing (1) the diameter of the nozzle bore over time during printing and (2) the mass of drops over time during printing, according to an embodiment.

FIG. 4 depicts a flowchart of a method for clearing the occlusion from the nozzle of the 3D printer, according to an embodiment.

FIG. 5 depicts a schematic cross-sectional side view of another 3D printer, according to an embodiment.

FIG. 6 depicts a schematic cross-sectional side view of a portion of another (e.g., inkjet) printer, according to another embodiment.

FIG. 7 depicts a flowchart of a method for controlling a viscosity of a build material within the 3D printer, according to an embodiment.

### DETAILED DESCRIPTION

Reference will now be made in detail to exemplary embodiments of the present teachings, examples of which are illustrated in the accompanying drawings. Wherever possible, the same reference numbers will be used throughout the drawings to refer to the same, similar, or like parts.

### Occlusion Prevention/Clearance

The present disclosure includes a 3D printer and method configured to clear an occlusion from within a nozzle of the 3D printer without physically contacting the nozzle (e.g., with a scrape, probe, etc.). The method may be implemented with minimal disruption to the printing process and no additional hardware requirements.

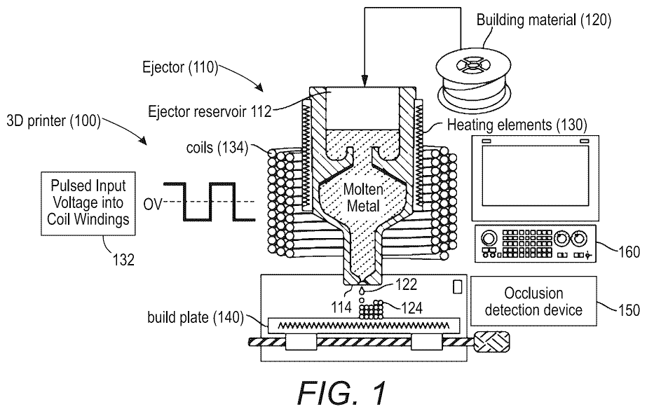

FIG. 1 depicts a schematic cross-sectional side view of a 3D printer 100, according to an embodiment. The 3D printer 100 may be or include a magnetohydrodynamic (MHD) printer, a piezoelectric-driven printer, or the like. The 3D printer 100 may include an ejector (also referred to as a pump) 110. As used herein, the ejector 110 refers to a structure that can be selectively activated to cause a build material 120 to be ejected from a nozzle 114 of the ejector 110. As used herein, the nozzle 114 refers to a physical structure from which the build material 120 begins flight.

The ejector 110 may define one or more reservoirs 112. One ejector reservoir 112 is shown in FIG. 1. In another embodiment, the ejector 110 may include two or more reservoirs including at least a first (e.g., upper) reservoir and a second (e.g., lower) reservoir. In this embodiment, the portion of the ejector 110 defining the upper reservoir may be or include a ceramic material, and the portion of the ejector 110 defining the lower reservoir may be or include a graphite material.

The ejector reservoir(s) 112 is/are configured to receive and/or store the build material 120 that is to be ejected from the nozzle 114. The build material 120 may be or include a metal (e.g., pure or an alloy), a polymer, a ceramic, ink, or the like. In one embodiment, the build material 120 may be greater than about 50% metal, greater than 60% metal, greater than 70% metal, greater than 80% metal, greater than 90% metal, or about 100% metal (e.g., by volume and/or mass). For example, the build material 120 may be or include a spool of aluminum wire (e.g., 6061 aluminum). In another embodiment, the build material 120 may be or include copper or other metals.

The 3D printer 100 may also include one or more heating elements 130. The heating elements 130 are configured to melt the build material 120 within the ejector reservoir 112, thereby converting the build material 120 from a solid state to a liquid (e.g., molten) state within the ejector reservoir 112.

The 3D printer 100 may also include a power source 132 and one or more metallic coils 134. The metallic coils 134 are wrapped at least partially around the ejector 110 and/or the heating elements 130. The power source 132 may be coupled to the coils 134 and configured to provide power thereto. In one embodiment, the power source 132 may be configured to provide a step function direct current (DC) voltage profile (e.g., voltage pulses or jetting pulses) to the coils 134, which may create an increasing magnetic field. The increasing magnetic field may cause an electromagnetic and/or electromotive force within the ejector 110, that in turn causes an induced electrical current in the liquid build material 120. The magnetic field and the induced electrical current in the liquid build material 120 may create a radially inward force on the liquid build material 120, known as a Lorentz force. The Lorentz force creates a pressure at an inlet of the nozzle 114 of the ejector 110. The pressure causes the liquid build material 120 to be jetted through and/or ejected from the nozzle 114 in the form of one or more drops 122.

The 3D printer 100 may also include a build plate (also referred to as a substrate) 140 that is positioned below the nozzle 114. The drops 122 may be ejected from the nozzle 114 and subsequently land on the build plate 140 where they may cool and solidify to form a first (e.g., bottom) layer. Additional drops 122 may be jetted to form layer upon layer that eventually produces a 3D part 124.

The 3D printer 100 may also include an occlusion detection device 150. In one embodiment, the occlusion detection device 150 may be or include a camera or a (e.g., laser) scanner that is configured to capture a feed (e.g., video and/or images) of the nozzle 114, the drops 122, the 3D part 124, or a combination thereof. In one example, the camera may be configured to capture the feed of the inner surface (e.g., inner diameter) of the nozzle 114, which may show the occlusion therein. The size and/or shape of the occlusion may be determined based upon the feed. The effective diameter of the nozzle bore may also be determined based upon the feed. In another example, the camera may be configured to capture the feed of the drops 122 as they are falling. More particularly, the feed may show the drops 122 after they are ejected from the nozzle 122 and before they land on the build plate 140. The size, shape, mass, and/or direction of the drops 122 may be determined based upon the feed.

In another embodiment, the occlusion detection device 150 may be or include a sensor configured to measure the height of the 3D part 124 along the Z-axis (i.e., z-height). The most recent height measurement may be compared to previous height measurements. If the recent height and/or the change in height is less than a predetermined height threshold, it may be determined that the mass of the drops 122 has decreased below a predetermined drop mass threshold. This may indicate that an occlusion is present in the nozzle bore.

In yet another embodiment, the occlusion detection device 150 may be configured to measure the amount and/or rate at which the build material (e.g., aluminum wire) 120 is fed into the ejector 110 (i.e., the input) using an encoder on the wire feed. The diameter of the wire is known within a tolerance. This, combined with the known density of the build material 120 can be used to determine the mass per unit time that build material 120 is being fed into the head. When averaged over a period of time (e.g., 1 minute), the input should be fairly close to the amount of build material 120 being ejected over that same period, assuming that the reservoir's level control is holding the reservoir height steady at the desired value. Dividing that by the number of drops ejected in that same time period gives the average drop mass. If that mass decreases by more than a predetermined input/output threshold for longer than a predetermined period of time (e.g., 1 minute), the occlusion detection device 150 may determine that the mass of the drops 122 has decreased below the predetermined drop mass threshold. This may indicate that an occlusion is present in the nozzle bore.

In yet another embodiment, the occlusion detection device 150 may be configured to pause printing and cause a known number of drops 122 to be ejected and weighed at predetermined intervals (e.g., every 10 minutes). This may also or instead be performed between print jobs. The measured weight may be compared to the previous measured weight(s). It may be determined that the mass of the drops 122 has decreased below the predetermined drop mass threshold in response to the comparison and/or the newest weight (e.g., being below a predetermined weight threshold). This may indicate that an occlusion is present in the nozzle bore.

In yet another embodiment, the occlusion detection device 150 may be configured to cause the 3D printer 100 to print a pillar (i.e., a narrow, vertical 3D part), and measure the height of the pillar. The measured height may be compared to the previous measured height(s). It may then be determined that the mass of the drops 122 has decreased below the predetermined drop mass threshold in response to the comparison and/or the newest height (e.g., being below a predetermined height threshold). This may indicate that an occlusion is present in the nozzle bore.

In an embodiment, the occlusion detection device 150 and/or an operator may determine that the drop mass is below the predetermined drop mass threshold, indicating that an occlusion is present in the nozzle 114, by seeing and/or sensing the presence of satellites that were not present earlier. This may show up as dust on and/or around the 3D part 124. This may also or instead show up as small drops (e.g., less than 10% of the size of the intended drops), which may be detected by the human eye, a camera, or stroboscope.

The occlusion may form on one side of the nozzle bore and interfere with the directionality of the stream of drops 122. Thus, in another embodiment, the occlusion detection device 150 and/or an operator may determine that an occlusion is present in the nozzle 114 by determining that the stream of drops 122 is exiting the nozzle 114 at an angle that is greater than a predetermined angle threshold (e.g., 5 degrees) in comparison to straight down.

The occlusion may also affect the build quality of the 3D part 124. Thus, in another embodiment, the occlusion detection device 150 and/or an operator may determine that an occlusion is present in the nozzle 114 by seeing/determining that the jetting quality and/or the build quality has degraded and/or drop speeds are inconsistent. This may be seen with a strobe and/or as the build quality of the 3D part 124 being below a predetermined quality threshold.

The 3D printer 100 may also include a computing system 160. As described below, the computing system 160 may perform at least a portion of the method described below to help prevent and/or remove the occlusion from the nozzle bore to increase the effective diameter thereof.

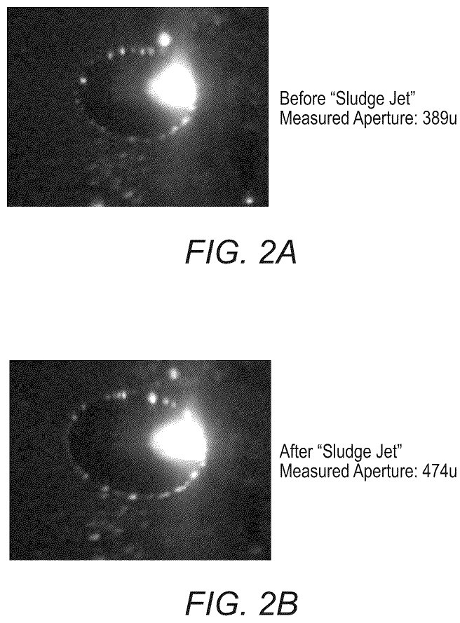

FIG. 2A depicts an image captured by the occlusion detection device 150 showing the nozzle bore with an occlusion therein, according to an embodiment. FIG. 2A is captured before a sludge jetting process is performed, as described below. Due to the presence of the occlusion in the nozzle bore, the effective cross-sectional length (e.g., diameter) of the nozzle bore is 389 micrometers (μm).

FIG. 2B depicts an image captured by the occlusion detection device 150 showing the nozzle bore with no occlusion therein, according to an embodiment. FIG. 2B is captured after the sludge jetting process has been performed to remove the occlusion. After the occlusion has been removed, the effective cross-sectional length (e.g., diameter) of the bore is 474 μm.

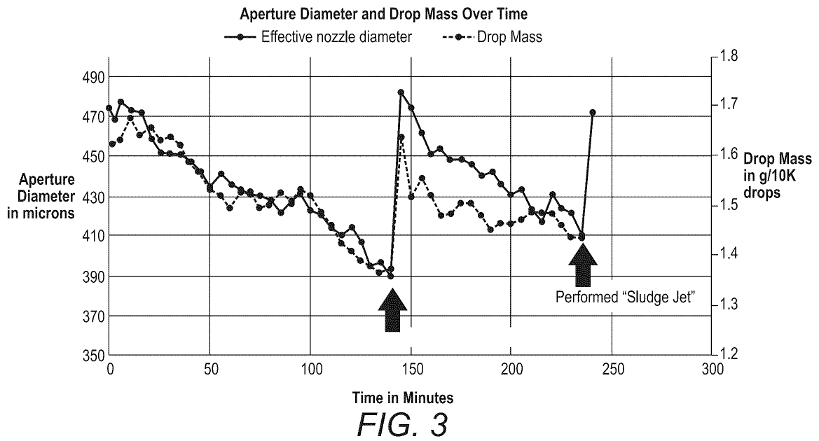

FIG. 3 depicts a graph showing (1) the diameter of the nozzle bore over time during printing and (2) the mass of the drops 122 over time during printing, according to an embodiment. As may be seen, the diameter and the mass may decrease over time due to the gradual build-up of the occlusion in the nozzle 114. In this particular example, during a first time period of printing (e.g., from 0 minutes to about 140 minutes), the diameter decreases from about 480 μm to about 390 μm, and the drop mass decreases from about 1.7 g/10 k drops to about 1.35 g/10 k drops. After the first time period, a first sludge jetting process is performed to remove the occlusion. This increases the diameter back up to about 480 μm and increases the drop mass back up to about 1.65 g/10 k drops. Then, during a second time period of printing (e.g., from 142 minutes to about 240 minutes), the diameter decreases from about 480 μm to about 410 μm, and the drop mass decreases from about 1.65 g/10k drops to about 1.45 g/10 k drops. After the second time period, a second sludge jetting process is performed to remove the occlusion. This increases the diameter back up to about 470 μm and increases the drop mass. This process may be repeated to help maintain the diameter above a predetermined diameter threshold and/or to maintain the drop mass above a predetermined drop mass threshold.

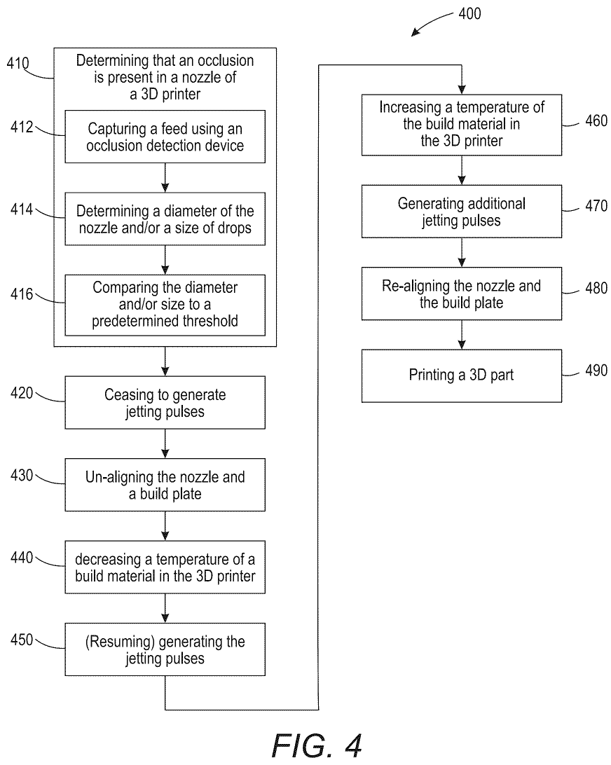

FIG. 4 depicts a flowchart of a method 400 for clearing an occlusion from the nozzle 114 of the 3D printer 100, according to an embodiment. One or more steps of the method 400 may be performed by the 3D printer 100 (e.g., the computing system 160). An illustrative order of the method 400 is provided below; however, one or more steps of the method 400 may be performed in a different order, repeated, combined, or omitted.

The method 400 may include determining that an occlusion is present in the nozzle 114 of the 3D printer 100, as at 410. In one embodiment, determining that the occlusion is present may include capturing a feed using the occlusion detection device 150, as at 412.

Determining that the occlusion is present may also include determining a diameter of the nozzle 114 and/or a size of the drops 122, as at 414. The diameter and/or size may be determined by the computing system 160 based upon the feed. The diameter may be or include an effective diameter. The effective diameter may refer to the diameter of the inner surface of the annular occlusion in the nozzle 114. The effective diameter may also or instead refer to the (e.g., smallest) diameter of the bore in the nozzle 114 through which the build material 120 may flow. The drop size may refer to the mass, volume, shape, diameter, or a combination thereof.

Determining that the occlusion is present may also include comparing the diameter and/or size to a predetermined threshold, as at 416. The comparison may be performed using the computing system 160. In an example, the predetermined nozzle diameter threshold may be from about 450 μm to about 470 μm, about 430 μm to about 450 μm, about 410 μm to about 430 μm, or about 390 μm to about 410 μm. In an example, the predetermined drop size threshold may be from about 1.6 g/10 k drops to about 1.7 g/10 k drops, about 1.5 g/10 k drops to about 1.6 g/10 k drops, about 1.4 g/10 k drops to about 1.5 g/10 k drops, or about 1.3 g/10 k drops to about 1.4 g/10 k drops.

The occlusion may be determined to be present based upon the comparison. In an example, the occlusion may be determined to be present (and/or of a certain size) in response to the measured/determined nozzle diameter being less than or equal to the predetermined diameter threshold. In another example, the occlusion may be determined to be present (and/or of a certain size) in response to the measured/determined drop size being less than or equal to the predetermined drop size threshold. In another embodiment, determining that the occlusion is present may be omitted from the method 400, and the following steps may be performed as a preventative measure.

The method 400 may also include ceasing to generate jetting pulses, as at 420. In other words, the jetting pulses generated by the power source 132 and transmitted to the coils 134 may be stopped. This may prevent the drops 122 from being ejected from the nozzle 114.

The method 400 may also include un-aligning the nozzle 114 and the build plate 140, as at 430. The nozzle 114 and the build plate 140 may be un-aligned in response to the determination that the occlusion is present in the nozzle 114. The nozzle 114 and the build plate 140 may be un-aligned while the jetting pulses are ceased such that no drops 122 are being ejected from the nozzle 114.

The nozzle 114 and the build plate 140 may be un-aligned such that subsequent drops 122 ejected from the nozzle 114 (described below) will not land on the build plate 140 and/or the 3D part 124 so as to not impact the 3D part 124 being printed. In an example, the nozzle 114 may be moved in the vertical direction, and the build plate 140 may (e.g., simultaneously) be moved in the horizontal direction. In another example, the nozzle 114 may be moved (and the build plate 140 may remain stationary) such that the nozzle 114 is no longer positioned over the build plate 140 and/or the 3D part 124. Rather, the nozzle 114 may be positioned over a waste tank, which is configured to receive the subsequent drops 122. In another example, the build plate 140 may be moved (and the nozzle 114 may remain stationary) such that the nozzle 114 is no longer positioned over the build plate 140 and/or the 3D part 124. The waste tank may then be positioned under the nozzle 114 to receive the subsequent drops 122. In yet another embodiment, rather than unaligning the nozzle 114 and the build plate 140, the waste tank may be positioned under the nozzle 114 and/or on the build plate 140.

The method 400 may also include decreasing a temperature of the build material 120 in the 3D printer 100, as at 440. The temperature of the build material 120 in the ejector reservoir 112 and/or the nozzle 114 may initially be above a melting point of the build material (e.g., aluminum) 120 during printing such that the build material 120 is in a liquid (e.g., molten) state in the ejector reservoir 112 and the nozzle 114. The melting point of aluminum is about 660° C. In an example, the temperature of the build material 120 in the ejector reservoir 112 may initially be about 825° C., and the temperature of the build material 120 in the nozzle 114 may initially be about 700° C. The temperature of the build material 120 in the nozzle 114 may be lower than in the ejector reservoir 112 because it is farther (e.g., downstream) from the heating elements 130.

In response to the occlusion being detected (as at 410), the movement of the nozzle 114 and/or build plate 140 (as at 420), the un-alignment (as at 430), or a combination thereof, the temperature of the build material 120 in the 3D printer 100 may be decreased. The temperature may be decreased while no jetting pulses are being generated such that no drops 122 are being ejected from the nozzle 114. Decreasing the temperature may be accomplished by reducing an amount of heat introduced into the ejector 110, the ejector reservoir 112, and/or the build material 120 via the heating elements 130. In another embodiment, the temperature may be decreased using a cooler.

The temperature may be decreased until the build material 120 in the nozzle 114 is below the melting point. Continuing with the example above, the temperature of the build material 120 in the ejector reservoir 112 may be decreased until it is about 700° C. (e.g., above the melting point), and the temperature of the build material 120 in the nozzle 114 may be decreased until it is about 600° C. (e.g., below the melting point). This may cause the build material 120 in the nozzle 114 to transition from the liquid state to a solid state (i.e., freeze) within the nozzle 114. The solidified build material 120 may attach to the occlusion in the nozzle 114 to form a unitary plug.

This step (i.e., decreasing the temperature) may be performed for a predetermined amount of time. In an example, the predetermined amount of time may be from about 1 second to about 10 seconds, about 10 seconds to about 30 seconds, about 30 seconds to about 1 minute, about 1 minute to about 2 minutes, or about 2 minutes to about 5 minutes. As will be appreciated, the predetermined amount of time may depend upon the amount of heat introduced to and/or removed from the build material 120 in the 3D printer 100. The predetermined amount of time may also depend upon the temperature to which the build material 120 is decreased. Thus, the more the temperature is decreased, the faster the build material 120 at least partially solidifies, and the quicker this step may be performed/completed.

The method 400 may also include (resuming) generating the jetting pulses, as at 450. The jetting pulses may be generated when the nozzle 114 is not positioned over the build plate 140 and/or the 3D part 124. The jetting pulses may also be generated while the temperature is decreased (e.g., when the build material 120 in the nozzle 114 is below the melting point and/or at least partially solidified therein). In an example, the jetting pulses may be generated when the build material 120 in the nozzle 114 is fully in the solid state.

The power source 132 may generate and transmit the jetting pulses to the coils 134, which may generate the forces that try to eject the drops 122 from the nozzle 114. With the build material 120 being at least partially solidified within the nozzle 114, the drops 122 may or may not be ejected from the nozzle 114 for a predetermined amount of time. Thus, neither the occlusion nor the build material 120 may ejected from the nozzle 114 for the predetermined amount of time after the jetting pulses are resumed.

However, the jetting pulses may generate heat within the nozzle 114. Thus, even if nothing is ejected for the predetermined amount of time after the jetting pulses are resumed, the jetting pulses may increase the temperature of the build material 120 in the nozzle 114 until the build material 120 is once again above its melting point. As a result, the build material 120 in the nozzle 114 may at least partially melt and transition from the solid state into a sludgy state (e.g., partially solid and partially liquid). Once in the sludgy state, the build material 120 may be ejected from the nozzle 114 (e.g., after the predetermined amount of time). The predetermined amount of time may be from about 1 second to about 10 seconds, about 10 seconds to about 30 seconds, about 30 seconds to about 1 minute, about 1 minute to about 3 minutes, or more. When the build material 120 in the sludgy state is ejected, it takes the occlusion with it out of the nozzle 114, thereby clearing the nozzle 114. This may be referred to as sludge jetting. As a result, the occlusion may be removed without physical contact from a scrape, probe, etc.

In one embodiment, the generation of jetting pulses may not generate enough heat to begin to melt the solidified (e.g., frozen) build material 120 in the nozzle 114. This may occur, for example, when the 3D printer 100 is driven by a piezoelectric device rather than by a MHD device. In this embodiment, instead of or in addition to generating the jetting pulses to generate the heat, another heater may be positioned at least partially around the nozzle 114 and configured to heat and melt the build material 120 therein. And as described above, as the build material 120 transitions into the sludgy state, it may be ejected from the nozzle 114 and take the occlusion with it.

The method 400 may also include increasing a temperature of the build material 120 in the 3D printer 100, as at 460. The temperature may be increased before, simultaneously with, or after the jetting pulses are generated (e.g., resumed). For example, the temperature may be increased before, simultaneously with, or after the sludgy build material 120 and/or the occlusion are ejected from the nozzle 114. The temperature may be increased using the heating elements 130 (e.g., around the ejector 110). The temperature may be increased back to the initial levels (e.g., about 825° C. in the ejector reservoir 112, and about 700° C. in the nozzle 114).

The method 400 may also include generating additional jetting pulses (or continuing to generate the jetting pulses), as at 470. The additional jetting pulses may be generated after the sludgy build material 120 and/or the occlusion have been ejected from the nozzle 114. The additional jetting pulses may cause a plurality of drops 122 to be ejected from the nozzle 114 and fall into the waste tank. These drops 122 may be analyzed (e.g., by the occlusion detection device 150 and/or the computing system 160) to determine/confirm that the 3D printer 100 has fully re-established the steady state. In other words, the drops 122 may be analyzed to determine/confirm that the drops 122 have a predetermined shape, size, mass, frequency, direction, or combination thereof.

The method 400 may also include re-aligning the nozzle 114 and the build plate 140, as at 480. The nozzle 114 and the build plate 140 may be re-aligned in response to the sludgy build material 120 and/or occlusion being ejected from the nozzle 114, the temperature of the build material 120 being increased, the determination/confirmation that the drops 122 have the predetermined shape, size, mass, frequency, direction, or a combination thereof. The nozzle 114 and the build plate 140 may be re-aligned such that subsequent drops 122 ejected from the nozzle 114 will land on the build plate 140 and/or the 3D part 124. In an example, the nozzle 114 may be moved (and the build plate 140 may remain stationary) such that the nozzle 114 is positioned over the build plate 140 and/or the 3D part 124. In another example, the build plate 140 may be moved (and the nozzle 114 may remain stationary) such that the nozzle 114 is positioned over the build plate 140 and/or the 3D part 124.

The method 400 may also include printing the 3D part 124, as at 490. The 3D part 124 may be printed (or printing may be resumed) after the sludgy build material 120 and occlusion have been ejected from the nozzle 114, and the nozzle 114 and the build plate 140 are re-aligned. Printing the 3D part 124 may include generating additional pulses to cause a plurality of drops 122 to be ejected from the nozzle 114. The drops 122 may land on the build plate 140 and/or a previously-deposited layer of the 3D part 124, where the drops 122 may cool and solidify to form a portion of the 3D part 124.

The method 400 may then loop back around to 410 to determine whether/that an occlusion is present in the nozzle 114 of the 3D printer 100, as at 410. This is shown in FIG. 3. In one embodiment, this determination may be made a predetermined amount of time after the sludgy build material 120 and occlusion have been ejected from the nozzle 114, the nozzle 114 and the build plate 140 are re-aligned, the 3D part 124 is printed, or a combination thereof. In another embodiment, this determination may be made after a predetermined amount of build material 120 is used and/or after a predetermined number of drops 122 are ejected.

In an embodiment, a decrease in drop mass may occur after sludge jetting (e.g., where the drop mass was previously running abnormally high for standard settings). The drop mass may settle back down into a more normal range after the sludge jetting. The abnormally high drop mass may be attributed to bubbles and/or non-wetted surfaces in the nozzle 114. The freeze/thaw cycle may help remove the bubbles and/or non-wetted area.

The method 400 may also be used as a preventative measure. In an example, the sludge jetting may be performed after the initial break-in of the 3D printer 100. In another example, the sludge jetting may be performed before building the 3D part 124. In another example, the sludge jetting may be performed after a predetermined amount of build material 120 is ejected and/or after a predetermined amount of time printing. For example, the sludge jetting may be performed before printing a first 3D part; in between smaller 3D parts/print jobs; and/or at every predetermined amount of jetting cycles for larger 3D parts.

### Viscosity Variation

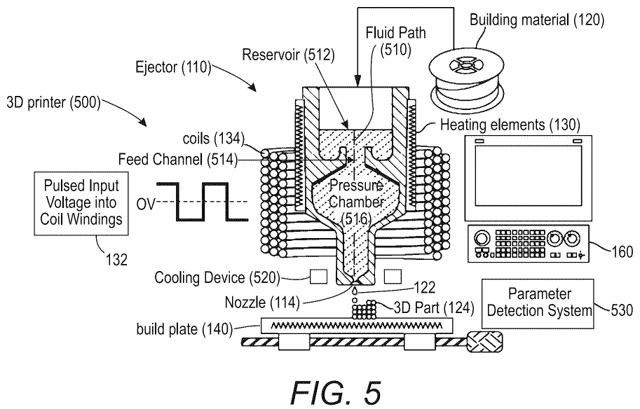

FIG. 5 depicts a schematic cross-sectional side view of another 3D printer 500, according to an embodiment. The 3D printer 500 may be similar to the printer 100, except for the differences described below. For example, the 3D printer 500 may include a cooling device 520. In one example, the cooling device 520 may be or include a cooled faceplate. For example, the cooling device 520 may include a metal (e.g., copper) piece in contact with the nozzle 114, in a form as a faceplate. Other effective cooling devices 520 may be or include any liquid cooling by forcing a coolant through internal channels around the nozzle 114. Other devices/methods such heat sink, forced air, etc., or in combination, can also be used.

The cooling device 520 may be positioned at least partially around a portion of the 3D printer 500 and configured to reduce the temperature of (i.e., cool) the nozzle 114 and/or the build material 120. In the embodiment shown, the cooling device 520 may be positioned at least partially around the nozzle 114 and configured to reduce the temperature of the build material 120 therein. In another embodiment, the cooling device 520 may be positioned vertically-between the nozzle 114 and the 3D part 124 or build plate 140 and configured to reduce the temperature of the falling drops 122. In yet another embodiment, the cooling device 520 may be positioned at least partially around the 3D part 124 and configured to reduce the temperature of the 3D part 124 (e.g., the recently-deposited, upper layer thereof). In yet another embodiment, the cooling device 520 may be positioned at least partially around or within the build plate 140 and configured to reduce the temperature of the build plate 140.

The build material 120 may flow through a fluidic path 510 in the 3D printer 500. For example, the build material 120 may flow in a downstream direction through the fluidic path 510 from a reservoir 512, a feed channel 514, a pressure chamber 516, and the nozzle 114. The fluidic path 510 may include a first (e.g., upstream) portion and a second (e.g., downstream) portion. The upstream portion may include the reservoir 512, the feed channel 514, the pressure chamber 516. or a combination thereof. The downstream portion may include the pressure chamber 516, the nozzle 114, or both. A length and/or volume of the downstream portion of the fluidic path 510 may be less than about 50%, less than about 40%, less than about 30%, less than about 20%, less than about 10%, less than about 5%, less than about 3%, or less than about 1% in comparison to a length and/or volume of the upstream portion of the fluidic path 510.

The 3D printer 500 (e.g., the heating elements 130) may maintain the build material 120 that is in the upstream portion of the fluidic path 510 in a relatively low-viscosity state. The 3D printer 500 (e.g., the cooling device 520) may cause the build material 120 in the downstream portion of the fluidic path 510 to be in a relatively high-viscosity state. Said another way, the viscosity of the build material 120 in the upstream portion of the fluidic path 510 may be below a predetermined viscosity threshold, and the build material 120 in the downstream portion of the fluidic path 510 may be above the predetermined viscosity threshold. For example, with aluminum alloys, the viscosity is typically around 1 cps (mPa·s) in the low-viscosity state. The predetermined viscosity threshold may be about 1.5 cps, about 2 cps, about 5 cps, about 10 cps, about 20 cps, about 50 cps, about 100 cps, or about 200 cps. In an example, the viscosity of the build material 120 in the downstream portion of the fluidic path 510 may initially be from about 0.5 cps to about 2 cps or about 1 cps to about 1.4 cps, and it may be increased by to be from about 5 cps to about 100 cps or about 10 cps to about 50 cps with the cooling device 520. Because the high-viscosity build material 120 only occupies a small portion of the fluidic path 510, the extra resistance caused by the high-viscosity build material 120 is proportionally small, and the jetting of the build material 120 and/or the ejection of the drops 122 can be achieved with little extra force/pressure.

In one embodiment, the viscosity of the build material 120 in the downstream portion of the fluidic path 510 may be controlled (e.g., increased) by controlling (e.g., decreasing) the temperature of the build material 120 in the downstream portion of the fluidic path 510 using the cooling device 520. The temperature of the build material 120 in the upstream portion of the fluidic path 510 may be above a predetermined temperature threshold, and the build material 120 in the downstream portion of the fluidic path 510 may be below the predetermined temperature threshold. The predetermined temperature threshold may be the melting point, the liquidus temperature, and/or the solidus temperature of the build material 120. For example, aluminum alloy 6061 has a solidus temperature of 582° C. and a liquidus temperature of 652° C., and the predetermined temperature may be about 630° C. In an example, the temperature of the build material 120 in the downstream portion of the fluidic path 510 may initially be from about 700° C. to about 900° C. or about 800° C. to about 850° C., and it may be decreased to be from about 500° C. to about 700° C. or about 600° C. to about 630°° C. The viscosity and/or temperature of the build material 120 in the upstream portion of the fluidic path 510 may be maintained (e.g., unaltered) by the cooling device 520.

As described above, the build material 120 may be a phase-changing material (e.g., a metal and/or alloy) that is configured to change to different material states in response to the viscosity and/or temperature variations. More particularly, a phase-changing material can transition between a liquid state and a solid state within a small temperature range. For each simple (e.g., pure) metal, there exists a single melting point, above which the metal is in the liquid state and below which the metal is in the solid state. For alloys, there is a liquidus temperature above which the alloy is a homogeneous liquid. There also exists a solidus temperature (e.g., lower than the liquidus temperature) below which the alloy is 100% solid. For temperatures between the solidus temperature and the liquidus temperature, the alloy is in a mixed (e.g., sludgy) state with varying fractions of solid and liquid. The viscosity of the build material 120 can go through large changes in this transition region. For example, the temperature of the build material 120 in the downstream portion of the fluidic path 510 (e.g., proximate to or within the nozzle 114) can be decreased by the cooling device 520 such that the build material 120 transitions into the sludgy state before being ejected from the nozzle 114.

Materials go through phase changes in response to the thermal/temperature changes. As a consequence, the viscosities also go through (e.g., rapid) changes. The systems and methods described herein take advantage of this change around the phase transition to enable jetting of materials at higher viscosity states and/or lower thermal energy states. For example, the viscosity at the downstream portion of the fluidic path 510 can be 25% higher than the viscosity at the mid or upstream portion of the fluidic path 510. In other embodiments, this increase in viscosity can be 50%, 2×, 5×, 10×, 20×, 50×, or 100×. In terms of phase transition, the solid fraction can be around 0% for the upper portion of the fluidic path 510, but greater than 1% for some sections of the lower fluidic path 510. In some embodiments, this solid fraction can be higher than 2%, 5%, 10%, 20%, 30%, 40%, or 50%. In terms of temperature control, it may be above the liquidus temperature along the mid to upper fluidic path. In the lower fluidic path or at least along some segment of this lower fluidic path, the temperature of the build material 120 may be above the solidus temperature and below the liquidus temperature. The solid fraction may increase as the temperature is lowered towards the solidus temperature, and reaches 100% when it is equal or lower than the solidus temperature. The exact rate of solidification in response to this temperature change is very specific to the composition of the actual build material. Because the build material 120 may still be in a transient state, the viscosity, the solid fraction, and/or the temperature may not be uniform throughout the downstream portion of the fluidic path 510. Thus, the viscosity and/or solid fraction values stated above may imply the maximum of the corresponding values in the downstream portion of the fluidic path 510 while the temperature values may imply the minimum temperatures reached in the downstream portion of the fluidic path 510.

The 3D printer 500 may also include a parameter detection device 530. The measured parameter may be the viscosity of the build material 120 in the upstream portion of the fluidic path 510, the downstream portion of the fluidic path 510, the drops 122, the 3D part 124, or a combination thereof. The measured parameter may also or instead be the temperature of the build material 120 in the upstream portion of the fluidic path 510, the downstream portion of the fluidic path 510, the drops 122, the 3D part 124, or a combination thereof. The measured parameter may also or instead be the force and/or pressure required to jet the build material 120 through the 3D printer 500 and/or eject the drops 122 from the nozzle 114. The measured parameter may also or instead be the size, shape, and/or frequency of the drops 122. The measured parameter may also or instead be the soaking and/or spreading of the drops 122 on the 3D part 124 and/or the build plate 140.

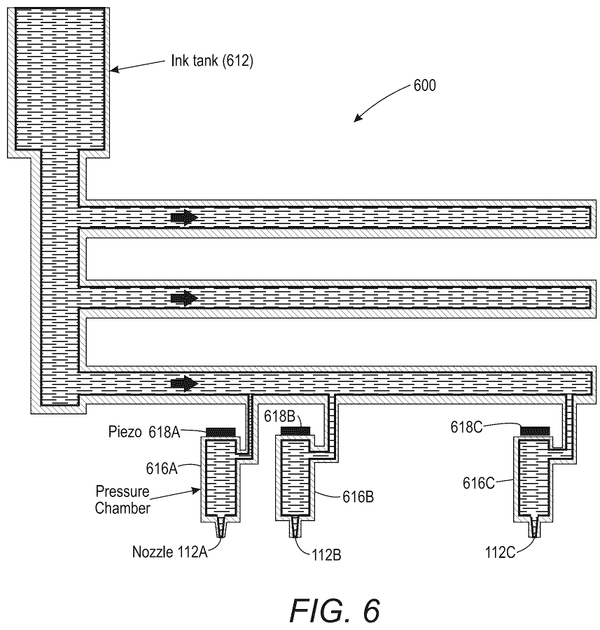

FIG. 6 depicts a schematic cross-sectional side view of a portion of another jetting device 600, according to another embodiment. The jetting device 600 may be or include a 3D printer, a conventional inkjet printer, or a jetting device for a variety of industrial applications. The jetting device 600 may include a tank 612 that is configured to receive the jetting material 120. In one example, the jetting material 120 may be ink, and thus, the tank 612 may be referred to as an ink tank. In another example, the jetting material 120 may be the same as the build material described above (e.g., metal). The jetting device 600 may also include one or more feed channels (three are shown: 614A-614C) in fluid communication with and downstream from the tank 612. The jetting device 600 may also include one or more pressure chambers (three are shown: 616A-616C) that are in fluid communication with and downstream from the channel(s) 614A-614C. The jetting device 600 may also include one or more piezo devices (three are shown: 618A-618C). In an example, the piezo devices 618A-618C may be or include piezoelectric devices. One piezo device (e.g., 618A) may be connected to a corresponding pressure chamber (e.g., 616A) and configured to generate the pressure/jetting pulses therein to jet the jetting material 120 therethrough. Each pressure chamber 616A-616C may include a nozzle 114A-114C) configured to eject a plurality of drops 122 of the jetting material 120 in response to the pressure/jetting pulses.

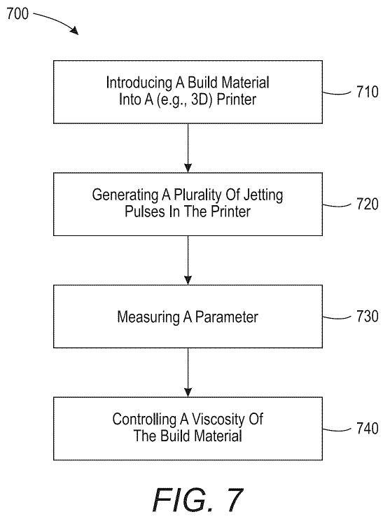

FIG. 7 depicts a flowchart of a method 700 for printing the 3D part 124, according to an embodiment. More particularly, the method 700 may be for controlling (e.g., increasing) a viscosity of the build material 120 within the downstream portion of the fluidic path 510 in the 3D printer 500 (e.g., proximate to the nozzle 114). An illustrative order of the method 700 is provided below; however, one or more steps of the method 700 may be performed in a different order, repeated, combined, or omitted.

The method 700 may include introducing the build material 120 into the 3D printer 500, as at 710. More particularly, this may include introducing the build material 120 into the ejector reservoir 112 in a solid state. The heating elements 130 may heat the build material 120, thereby causing the build material 120 to transition into a liquid (e.g., molten) state within the ejector reservoir 112.

The method 700 may also include generating a plurality of jetting pulses, as at 720. This may include the power source 132 generating and transmitting power pulses to the coils 134. In response to the power pulses, the coils 134 may generate the jetting pulses (also referred to as pressure pulses) within the ejector reservoir 112 that cause the drops 122 to be ejected from the nozzle 114.

The method 700 may also include measuring a parameter, as at 730. The parameter may be measured using the parameter detection device 530. The parameter may alternatively be determined using the computing system 160 based upon measurements made by the parameter detection device 530. As mentioned above, the parameter may be or include the viscosity of the build material 120, the temperature of the build material 120, the force to jet the build material 120 through the 3D printer 500 or eject the drops 122 from the nozzle 114, the pressure to jet the build material 120 through the 3D printer 500 or eject the drops 122 from the nozzle 114, the size of the drops 122, the shape of the drops 122, the frequency of the drops 122, the soaking and/or spreading of the drops 122 on the 3D part 124 or build plate 140, the spreading of the drops 122 on the 3D part 124 or build plate 140, or a combination thereof. The parameter may be measured at one or more locations along the fluidic path 510 (e.g., before ejection of the drops 122), in the drops 122, on the 3D part 124, on the substrate 140, or a combination thereof.

The method 700 may also include controlling the viscosity of the build material 120, as at 740. The viscosity may be controlled in response to the measured parameter. The 3D printer 500 (e.g., the computing system 160) may control (e.g., increase) the viscosity in the downstream portion of the fluidic path 510. The 3D printer 500 (e.g., the computing system 160) may accomplish this by causing the cooling device 520 to vary (e.g., decrease) the temperature of the build material 120 in the downstream portion of the fluidic path 510. In an embodiment, the build material 120 in the downstream portion of the fluidic path 510 may remain in the liquid state in response to the decreased temperature and/or increased viscosity. In another embodiment, the build material 120 may transition from the liquid state into the sludgy state in response to the decreased temperature and/or increased viscosity. The method 700 may then loop back around to step 710, 720, and/or 730 and repeat (i.e., the method 700 may be iterative).

In addition to the viscosity change associated with the phase change, there may also be a thermal/heat energy change. During the phase change between the liquid state and the sludgy and/or solid state, there may be excess heat to be released, known as the latent heat. Being in the high-viscosity state implies that part of this latent heat has already been released. Therefore, less cooling is required to solidify the ejected build material 120 (i.e., the drops 122 and/or the 3D part 124) and enable rapid solidification of the drops 122 and/or the 3D part 124.

Increasing the viscosity and/or lowering the heat energy may be particularly beneficial in liquid metal jetting 3D technology. In one example, increasing the viscosity and/or lowering the heat energy may be beneficial when printing a tip/edge of the 3D part 124. More particularly, at the extremes of the 3D part 124 (e.g., overhangs, sharp corners, thin walls, etc.), the heat loss/dissipation due to conduction (usually the main heat loss mechanism) through the main body of the 3D part 124 is limited, and rapid cooling is difficult. In another example, increasing the viscosity and/or lowering the heat energy may be beneficial during high-frequency jetting. As used herein, high-frequency jetting refers to jetting the drops 122 at a frequency that is greater than about 400 Hz for an example system. The rate of heat generated by the jetting mechanism of the 3D printer 500 may be proportional to the jetting frequency, the drop size/mass, thermal capacity of the jetting material and etc. What is considered high frequency is the rate at which the input thermal energy brought by the drops 122 is close to or exceeding the cooling capacity of the system 500. As a result, removing excess heat during the ejection of the drops 122 can be beneficial. In yet another example, increasing the viscosity and/or lowering the heat energy may be beneficial when the 3D printer 500 includes multi-nozzle jetting and/or arrays, as shown in FIG. 6. Multi-nozzle technology causes more heat to be generated in a small area, increasing the need for pulling heat out during the ejection of the drops 122.

The 3D printer 500 may take advantage of jetting high-viscosity build material 120 and/or jetting the build material 120 in the high viscosity state in at least two ways. First, the high viscosity limits the flow of the drops 122 upon impact with the 3D part 124 and/or the build plate 140. This is directly related to the high viscosity. Second, rapid solidification is associated with the phase-change build material 120 in the high-viscosity state. This is particularly applicable to liquid metal jetting related 3D printing.

### Clauses

1. A method for controlling a viscosity of a jetting material in a jetting device, the method comprising: introducing the jetting material into the jetting device, wherein the jetting material flows through a fluidic path in the jetting device, and wherein the fluidic path comprises an upstream portion and a downstream portion; and increasing a maximum viscosity of the jetting material in the downstream portion of the fluidic path to be at least 25% higher than the viscosity of the jetting material in the upstream portion of the fluidic path.
2. The method of clause 1, wherein the jetting device comprises a 3D printer configured to print a 3D part.
3. The method of clause 1, wherein the maximum viscosity of the jetting material in the downstream portion of the fluidic path is increased to be at least 50% higher than the viscosity of the jetting material in the upstream portion of the fluidic path.
4. The method of clause 1, wherein the maximum viscosity of the jetting material in the downstream portion of the fluidic path is increased to be at least 200% higher than the viscosity of the jetting material in the upstream portion of the fluidic path.
5. The method of clause 1, wherein the increase in the maximum viscosity of the jetting material in the downstream portion of the fluidic path causes a maximum solid fraction of the jetting material in the downstream portion of the fluidic path to be greater than about 1%.
6. The method of clause 1, wherein the increase in the maximum viscosity of the jetting material in the downstream portion of the fluidic path causes a maximum solid fraction of the jetting material in the downstream portion of the fluidic path to be greater than about 2%.
7. The method of clause 1, wherein the increase in the maximum viscosity of the jetting material in the downstream portion of the fluidic path causes a maximum solid fraction of the jetting material in the downstream portion of the fluidic path to be greater than about 5%.
8. The method of clause 1, wherein the maximum viscosity is increased by decreasing a temperature of the jetting material in the downstream portion of the fluidic path until a minimum temperature of the jetting material in the downstream portion of the fluidic path is above a solidus temperature of the jetting material and below a liquidus temperature of the jetting material.
9. The method of clause 1, wherein the maximum viscosity is increased by decreasing a temperature of the jetting material in the downstream portion of the fluidic path until a minimum temperature of the jetting material in the nozzle is above a solidus temperature of the jetting material and below a liquidus temperature of the jetting material.
10. The method of clause 1, wherein the maximum viscosity of the jetting material in the downstream portion of the fluidic path is increased to be from about 2 cps to about 100 cps.
11. The method of clause 1, wherein the jetting material comprises a metal.
12. The method of clause 1, wherein the upstream portion comprises an ejector reservoir of the jetting device, and wherein the downstream portion comprises a nozzle of the jetting device.
13. The method of clause 1, wherein a length, a volume, or both of the downstream portion of the fluidic path are less than about 20% in comparison to the length, the volume, or both of the upstream portion of the fluidic path.
14. The method of clause 1, further comprising measuring or determining a parameter, wherein the maximum viscosity is increased in response to the parameter.
15. The method of clause 14, wherein the parameter comprises the maximum viscosity of the jetting material, a temperature of the jetting material, a force to jet the jetting material through the jetting device or eject drops of the jetting material from the nozzle, a pressure to jet the jetting material through the jetting device or eject the drops from the nozzle, a size of the drops, a shape of the drops, a frequency of the drops, a soaking of the drops on a 3D part or a build plate, a spreading of the drops on the 3D part or the build plate, or a combination thereof.
16. The method of clause 14, wherein the parameter comprises the maximum viscosity of the jetting material or a temperature of the jetting material, and wherein the parameter is measured or determined in the downstream portion of the fluidic path or in drops of the jetting material that have been ejected from a nozzle of the jetting device.
17. A method for controlling a viscosity of a build material in a 3D printer, the method comprising: introducing the build material into the 3D printer, wherein the build material flows through a fluidic path in the 3D printer, and wherein the fluidic path comprises an upstream portion and a downstream portion; and increasing the viscosity of the build material in the downstream portion of the fluidic path, which causes a maximum solid fraction of the build material in the downstream portion of the fluidic path to be greater than about 1%.
18. The method of clause 17, wherein the viscosity is increased until the maximum solid fraction is greater than about 2%.
19. The method of clause 17, wherein the viscosity is increased until the maximum solid fraction is greater than about 5%.
20. The method of clause 17, wherein the viscosity is increased by decreasing a temperature of the build material in the downstream portion of the fluidic path until a minimum temperature of the build material in the downstream portion of the fluidic path is above a solidus temperature of the build material and below a liquidus temperature of the build material.
21. The method of clause 17, wherein the viscosity is increased by decreasing a temperature of the build material in the downstream portion of the fluidic path until a minimum temperature of the build material in the nozzle is above a solidus temperature of the build material and below a liquidus temperature of the build material.
22. The method of clause 17, wherein a maximum viscosity of the build material in the downstream portion of the fluidic path is increased to be from about 2 cps to about 100 cps.
23. The method of clause 17, wherein the build material comprises a metal.
24. The method of clause 17, wherein the upstream portion comprises an ejector reservoir of the 3D printer, and wherein the downstream portion comprises a nozzle of the 3D printer.
25. The method of clause 17, wherein a length, a volume, or both of the downstream portion of the fluidic path are less than about 20% in comparison to the length, the volume, or both of the upstream portion of the fluidic path.
26. The method of clause 17, further comprising measuring or determining a parameter, wherein the viscosity is increased in response to the parameter.
27. The method of clause 26, wherein the parameter comprises the viscosity of the build material, a temperature of the build material, a force to jet the build material through the 3D printer or eject drops of the build material from the nozzle, a pressure to jet the build material through the 3D printer or eject the drops from the nozzle, a size of the drops, a shape of the drops, a frequency of the drops, a soaking of the drops on a 3D part or a build plate, a spreading of the drops on the 3D part or the build plate, or a combination thereof.
28. The method of clause 26, wherein the parameter comprises the viscosity of the build material or a temperature of the build material, and wherein the parameter is measured or determined in the downstream portion of the fluidic path or in drops of the build material that have been ejected from a nozzle of the 3D printer.
29. The method of clause 17, wherein the viscosity is increased to above a predetermined viscosity threshold, and wherein the viscosity of the build material in the upstream portion of the fluidic path remains below the predetermined viscosity threshold.
30. The method of clause 29, wherein the predetermined viscosity threshold is about 10 cps.
31. A method for controlling a temperature of a build material in a 3D printer, the method comprising: introducing the build material into the 3D printer, wherein the build material flows through a fluidic path in the 3D printer, and wherein the fluidic path comprises an upstream portion and a downstream portion; and decreasing the temperature of the build material in the downstream portion of the fluidic path until a minimum temperature in the downstream portion of the fluidic path is above a solidus temperature of the build material and below a liquidus temperature of the build material.
32. The method of clause 31, wherein the downstream portion of the fluidic path comprises a nozzle of the 3D printer.
33. The method of clause 31, wherein decreasing the temperature of the build material in the downstream portion of the fluidic path increases a viscosity of the build material in the downstream portion of the fluidic path.
34. The method of clause 31, wherein the temperature of the build material in the upstream portion of the fluidic path remains above the liquidus temperature of the build material.
35. The method of clause 31, wherein the temperature is decreased using a cooling device positioned at least partially around a nozzle of the 3D printer.
36. The method of clause 31, wherein the temperature is decreased until a viscosity of the build material in the downstream portion of the fluidic path from about 2 cps to about 100 cps.
37. The method of clause 31, wherein the temperature is decreased until a viscosity of the build material in the downstream portion of the fluidic path from about 5 cps to about 75 cps.
38. The method of clause 31, wherein the build material comprises a metal.
39. The method of clause 31, wherein the upstream portion comprises an ejector reservoir of the 3D printer, and wherein the downstream portion comprises a nozzle of the 3D printer.
40. The method of clause 31, wherein a length, a volume, or both of the downstream portion of the fluidic path are less than about 20% in comparison to the length, the volume, or both of the upstream portion of the fluidic path.
41. The method of clause 31, further comprising measuring or determining a parameter, wherein the temperature is decreased in response to the parameter.
42. The method of clause 41, wherein the parameter comprises a viscosity of the build material, the temperature of the build material, a force to jet the build material through the 3D printer or eject drops of the build material from the nozzle, a pressure to jet the build material through the 3D printer or eject the drops from the nozzle, a size of the drops, a shape of the drops, a frequency of the drops, a soaking of the drops on a 3D part or a build plate, a spreading of the drops on the 3D part or the build plate, or a combination thereof.
43. The method of clause 41, wherein the parameter comprises a viscosity of the build material or the temperature of the build material, and wherein the parameter is measured or determined in the downstream portion of the fluidic path or in drops of the build material that have been ejected from a nozzle of the 3D printer.
44. The method of clause 31, wherein decreasing the temperature causes the viscosity of the build material in the downstream portion of the fluidic path to increase to above a predetermined viscosity threshold, and wherein the viscosity of the build material in the upstream portion of the fluidic path remains below the predetermined viscosity threshold.

Notwithstanding that the numerical ranges and parameters setting forth the broad scope of the present teachings are approximations, the numerical values set forth in the specific examples are reported as precisely as possible. Any numerical value, however, inherently contains certain errors necessarily resulting from the standard deviation found in their respective testing measurements. Moreover, all ranges disclosed herein are to be understood to encompass any and all sub-ranges subsumed therein. For example, a range of “less than 10” may include any and all sub-ranges between (and including) the minimum value of zero and the maximum value of 10, that is, any and all sub-ranges having a minimum value of equal to or greater than zero and a maximum value of equal to or less than 10, e.g., 1 to 5.

While the present teachings have been illustrated with respect to one or more implementations, alterations and/or modifications may be made to the illustrated examples without departing from the spirit and scope of the appended claims. For example, it may be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or embodiments of the present teachings. It may be appreciated that structural objects and/or processing stages may be added, or existing structural objects and/or processing stages may be removed or modified. Further, one or more of the acts depicted herein may be carried out in one or more separate acts and/or phases. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items may be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “conformal” describes a coating material in which angles of the underlying material are preserved by the conformal material. The term “about” indicates that the value listed may be somewhat altered, as long as the alteration does not result in nonconformance of the process or structure to the illustrated embodiment. The terms “couple,” “coupled,” “connect,” “connection,” “connected,” “in connection with,” and “connecting” refer to “in direct connection with” or “in connection with via one or more intermediate elements or members.” Finally, the terms “exemplary” or “illustrative” indicate the description is used as an example, rather than implying that it is an ideal. Other embodiments of the present teachings may be apparent to those skilled in the art from consideration of the specification and practice of the disclosure herein. It is intended that the specification and examples be considered as exemplary only, with a true scope and spirit of the present teachings being indicated by the following claims.

What is claimed is:

1. A method for printing a 3D part, the method comprising:
decreasing a temperature of a build material in a nozzle of a 3D printer below a melting point of the build material, which causes the build material in the nozzle to transition from a liquid state to a solid state; and
increasing the temperature of the build material in the nozzle above the melting point of the build material, which causes the build material in the nozzle to transition from the solid state to a sludgy state, wherein an occlusion and the build material in the sludgy state are ejected from the nozzle.

2. The method of claim 1, wherein the build material comprises a metal alloy.

3. The method of claim 1, wherein the occlusion comprises a substantially annular ring including a metal oxide that is attached to an inner surface of the nozzle, which reduces an effective diameter of a bore through the nozzle.

4. The method of claim 1, further comprising determining that the occlusion is present within the nozzle, wherein the temperature is decreased in response to determining that the occlusion is present.

5. The method of claim 4, further comprising:
ceasing to generate jetting pulses in response to the determination that the occlusion is present, which stops drops of the build material from being ejected from the nozzle; and
resuming generating the jetting pulses after the temperature is decreased.

6. The method of claim 4, further comprising:
un-aligning the nozzle from a build plate after the occlusion has been determined to be present; and
re-aligning the nozzle with the build plate after the temperature is increased.

7. The method of claim 1, wherein the temperature is increased by generating jetting pulses, which generates heat within the nozzle.

8. The method of claim 7, wherein, in addition to increasing the temperature, the jetting pulses also cause the occlusion and the build material in the sludgy state to be ejected from the nozzle together, thereby increasing an effective diameter of a bore through the nozzle.

9. The method of claim 1, wherein the temperature is increased by an external heater positioned at least partially around the nozzle.

10. The method of claim 1, wherein the temperature is further increased by a heating element positioned upstream from the nozzle after the occlusion and the build material in the sludgy state are ejected from the nozzle.

11. The method of claim 1, further comprising printing a 3D part with the build material after the occlusion and the build material in the sludgy state are ejected from the nozzle.

12. The method of claim 1, wherein the temperature is decreased and then increased before the 3D part is printed or after the 3D part is printed.

13. The method of claim 1, wherein the temperature is decreased and then increased after a first portion of the 3D part is printed and before a second portion of the 3D part is printed.

14. The method of claim 1, wherein the temperature is decreased and then increased after a predetermined amount of the build material is ejected from the nozzle.

15. The method of claim 1, wherein the temperature is decreased and then increased after a predetermined amount of time of ejecting the build material from the nozzle.

16. A method for clearing an occlusion from a nozzle of a 3D printer, the method comprising:
determining that the occlusion is present within the nozzle, wherein the occlusion comprises a substantially annular ring including a metal oxide that is attached to an inner surface of the nozzle, which reduces an effective diameter of a bore through the nozzle;
ceasing to generate jetting pulses, which stops drops of a build material from being ejected from the nozzle, wherein the build material comprises a metal;
un-aligning the nozzle from a build plate;
decreasing a temperature of the build material in the 3D printer, which causes a portion of the build material in the nozzle to fall below a melting point of the build material and thus transition from a liquid state to a solid state within the nozzle;
resuming generating the jetting pulses, which generates heat within the nozzle that at least partially melts the build material therein such that the build material transitions from the solid state to a sludgy state in the nozzle, wherein the jetting pulses cause the occlusion and the build material in the sludgy state to be ejected from the nozzle together, thereby increasing the effective diameter of the bore through the nozzle;
increasing the temperature of the build material in the 3D printer using a heating element to cause the build material in the nozzle to be in the liquid state, wherein the temperature is increased after the occlusion and the build material in the sludgy state are ejected from the nozzle;
re-aligning the nozzle and the build plate after the temperature of the build material is increased; and
printing a 3D part with the build material on the build plate once the nozzle and the build plate are re-aligned.

17. The method of claim 16, wherein determining that the occlusion is present comprises:
capturing a feed using an occlusion detection device, wherein the occlusion detection device comprises a camera, and wherein the feed comprises video or images of an interior of the nozzle, the drops ejected from the nozzle, or both;
determining the effective diameter of the bore based upon the feed; and
comparing the effective diameter to a predetermined nozzle diameter threshold, wherein the occlusion is determined to be present based upon the comparison.

18. The method of claim 16, wherein determining that the occlusion is present comprises:
capturing a feed using an occlusion detection device, wherein the occlusion detection device comprises a camera, and wherein the feed comprises video or images of an interior of the nozzle, the drops ejected from the nozzle, or both;
determining a size of the drops based upon the feed; and
comparing the size to a predetermined drop size threshold, wherein the occlusion is determined to be present based upon the comparison.

19. The method of claim 16, wherein another portion of the build material that is upstream from the nozzle remains in the liquid state in response to the temperature being decreased.

20. The method of claim 16, wherein neither the occlusion nor the build material are ejected from the nozzle for a predetermined amount of time while the jetting pulses are resumed, wherein the jetting pulses cause the occlusion and the build material in the sludgy state to be ejected from the nozzle after the predetermined amount of time, and wherein the predetermined amount of time is from about 10 seconds to about 3 minutes.

21. A method for printing a 3D part, the method comprising:
ejecting a metal alloy from a nozzle of a 3D printer using an electromagnetic force, wherein the metal alloy cools and solidifies after being ejected to form the 3D part;
determining that an occlusion is present within the nozzle;
decreasing a temperature of the metal alloy in the nozzle below a melting point of the metal alloy, which causes the metal alloy in the nozzle to transition from a liquid state to a solid state; and
increasing the temperature of the metal alloy in the nozzle above the melting point of the metal alloy, which causes the metal alloy in the nozzle to transition from the solid state to a sludgy state, wherein the occlusion and the metal alloy in the sludgy state are ejected from the nozzle.

22. The method of claim 21, further comprising transmitting power pulses to one or more coils, wherein pulses of the electromagnetic force are generated in the nozzle in response to the one or more coils receiving the power pulses, and wherein the temperature of the metal alloy in the nozzle increases in response to the pulses of the electromagnetic force.

23. The method of claim 22, wherein, in addition to increasing the temperature, the pulses of the electromagnetic force also cause the occlusion and the metal alloy in the sludgy state to be ejected from the nozzle together, thereby increasing an effective diameter of a bore through the nozzle.

24. The method of claim 22, further comprising increasing the temperature of the metal alloy using a heating element to cause the metal alloy in the nozzle to transition back into the liquid state, wherein the temperature is increased using the heating element after the occlusion and the metal alloy in the sludgy state are ejected from the nozzle.

25. The method of claim 21, wherein determining that the occlusion is present within the nozzle comprises:
measuring a height of the 3D part; and
determining that the height is less than a predetermined height threshold.

26. The method of claim 21, wherein determining that the occlusion is present within the nozzle comprises comparing an amount or rate of the metal alloy being introduced into the 3D printer with an amount or rate of the metal alloy being ejected from the nozzle of the 3D printer.

27. The method of claim 21, wherein determining that the occlusion is present within the nozzle comprises:
ejecting a predetermined number of drops of the metal alloy from the nozzle; and
determining that a mass or a volume of the predetermined number of drops of the metal alloy is less than a predetermined threshold.

28. The method of claim 21, wherein determining that the occlusion is present within the nozzle comprises:
ejecting a predetermined number of drops of the metal alloy from the nozzle at a first time;
ejecting the predetermined number of drops of the metal alloy from the nozzle at a second time, wherein the first time and the second time are separated by one minute or more; and
determining that a mass or a volume of the predetermined number of drops of the metal alloy ejected at the first time is greater than the mass or the volume of the predetermined number of drops of the metal alloy ejected at the second time by more than a predetermined threshold.

29. The method of claim 21, wherein determining that the occlusion is present within the nozzle comprises detecting satellites of the metal alloy around the 3D part, and wherein a mass of each satellite is less than 50% of a mass of a drop of the metal alloy.

30. The method of claim 21, wherein determining that the occlusion is present within the nozzle comprises:
measuring an angle at which the metal alloy is ejected from the nozzle; and
comparing the measured angle to vertical, wherein the occlusion is determined to be present in response to a difference between the measured angle and vertical being greater than a predetermined angle threshold.

31. The method of claim 21, wherein determining that the occlusion is present within the nozzle comprises determining that a speed at which drops of the metal alloy are ejected from the nozzle is below a predetermined speed threshold.

32. A 3D printer, comprising:
a nozzle configured to eject a plurality of drops of a build material; and
a computing system configured to perform operations, the operations comprising:
causing a temperature of the build material in the nozzle to decrease below a melting point of the build material, which causes the build material in the nozzle to transition from a liquid state to a solid state; and
causing the temperature of the build material in the nozzle to increase above the melting point of the build material, which causes the build material in the nozzle to transition from the solid state to a sludgy state, wherein an occlusion and the build material in the sludgy state are ejected from the nozzle.

33. The 3D printer of claim 32, wherein the operations further comprise:
determining that an occlusion is present within the nozzle;
ceasing to generate jetting pulses in response to the determination that the occlusion is present, which stops the drops from being ejected from the nozzle; and
resuming generating the jetting pulses after the temperature is decreased.

34. The 3D printer of claim 32, further comprising:
a power source configured to provide power; and
a metallic coil configured to generate jetting pulses in response to receiving the power, wherein the jetting pulses cause the temperature of the build material in the nozzle to increase above the melting point of the build material.

35. The 3D printer of claim 34, wherein, in addition to increasing the temperature, the jetting pulses also cause the occlusion and the build material in the sludgy state to be ejected from the nozzle together, thereby increasing an effective diameter of a bore through the nozzle.

36. The 3D printer of claim 32, further comprising a heating element positioned upstream from the nozzle, wherein the heating element begins to further increase the temperature after the occlusion and the build material in the sludgy state are ejected from the nozzle.
